(19) United States
(12) Patent Application Publication
(10) Pub. No.: US 2016/0173479 A1
(43) Pub. Date: Jun. 16, 2016

(54) Terminal Authentication Method, Apparatus, and System in Passive Optical Network

(71) Applicant: Huawei Technologies Co., Ltd., Shenzhen (CN)

(72) Inventors: Lun Zhang, Shenzhen (CN); Xifeng Wan, Shenzhen (CN)

(21) Appl. No.: 15/048,564

(22) Filed: Feb. 19, 2016

Related U.S. Application Data
(63) Continuation of application No. PCT/CN2013/082079, filed on Aug. 22, 2013.

(51) Int. Cl. H04L 29/06; H04B 10/27; H04B 10/85

(52) U.S. Cl. CPC H04L 63/08; H04L 63/0876; H04B 10/85; H04B 10/27

(57) ABSTRACT

A terminal authentication method in a passive optical network (PON) which includes, receiving, by the optical line terminal (OLT), a registration request that carries an authentication parameter and is sent by the optical network terminal (ONT), where the authentication parameter is used to identify the ONT of a same type, and determining, by the OLT, that the authentication parameter sent by the ONT matches the authentication parameter preconfigured on the OLT, and authorizing that the ONT is an authorized terminal. Using the foregoing technical solutions, an OLT may be, during optical network unit (ONU) registration and authentication, plug-and-play, without needing to manually input authentication information, which improves automation and flexibility of authentication.

### CROSS REFERENCE TO RELATED APPLICATIONS

This application is a continuation of International Application No. PCT/CN2013/082079, filed on Aug. 22, 2013, which is hereby incorporated by reference in its entirety.

### TECHNICAL FIELD

The present disclosure relates to the field of network communications technologies, and in particular, to a terminal authentication method, apparatus, and operation management system in a passive optical network.

### BACKGROUND

A passive optical network (PON) is an optical network of a point to multi-point (P2MP) structure. At present, representative PON technologies are the gigabit-capable passive optical network (GPON) and Ethernet passive optical network (EPON), where a GPON technology has features such as a high line rate and an improved maintenance and management function. A typical PON network is formed by an optical line terminal (OLT), an optical network unit (ONU), and an optical distribution network (ODN). The PON has features of a P2MP structure and downlink broadcasting. Therefore, to configure different service data for ONUs of different sites and control security of registration, the optical line terminal (OLT) needs to perform authentication on the ONU. The ONU/optical network terminal (ONT) authentication is implemented in a process of registering the ONU/ONT. Generally, ONU authentication manners include serial number (SN) authentication, password authentication, and logical ONU identifier (LOID)+Password (LOID and password) authentication. For example, the SN authentication is the SN of the ONU recorded on an ONU installation site, and the same SN then input on an OLT side. The OLT receives the SN reported by the ONU in the registration, and verifies that both SNs are consistent, that is, the authentication succeeds. Generally, the following steps are included.

Step 1: The OLT sends an initialization and ready message to each ONU.

Step 2: The OLT sends a message for requesting the ONU to report the SN to each ONU.

Step 3: After receiving the message for requesting the SN, the ONU sends a SN message to the OLT.

Step 4: The OLT receives the SN and performs detection on the SN.

Step 5: The OLT completes ranging of the ONU/ONT to which an ONU-ID is allocated.

Step 6: The OLT performs authentication on the ONU according to the received SN. After the authentication succeeds, the ONU registration succeeds.

At present, for each of the foregoing ONU authentication manners, authentication information needs to be manually input on the OLT side. For example, in the foregoing authentication process, the SN or password information needs to be manually input. The manual authentication process is tedious, and an error may occur easily. In addition, the authentication takes a long time, and user experience is poor.

### SUMMARY

In view of this, embodiments of the present disclosure provide a terminal authentication method, apparatus, and system in a passive optical network. It is unnecessary to manually input authentication information on an OLT side, which improves automation and flexibility of authentication and enhances user experience.

According to a first aspect, an embodiment of the present disclosure provides a terminal authentication method in a passive optical network, where the PON includes an OLT and at least one ONT, the OLT is connected to the at least one ONT using an optical distribution network, and an authentication parameter is preconfigured on the OLT. The terminal authentication method includes receiving, by the OLT, a registration request that carries the authentication parameter and is sent by the optical network terminal, where the authentication parameter is used to identify the ONT of a same type, and determining, by the OLT, that the authentication parameter sent by the ONT matches the authentication parameter preconfigured on the OLT, and confirming that the ONT of the same type is an authorized ONT.

In a first possible implementation manner of the first aspect, the method further includes recording, by the OLT, a terminal serial number obtained from the authorized terminal, and recording a terminal identifier (ID) allocated for the authorized ONT.

In a second possible implementation manner of the first aspect, the authentication parameter is transmitted using an ONT management and control interface (OMCI) message.

In a third possible implementation manner of the first aspect, before the receiving, by the OLT, a registration request that carries the authentication parameter and is sent by the ONT, the method further includes receiving, by the OLT, a terminal serial number sent by the ONT, and allocating a temporary terminal ID for the ONT, and requesting, by the OLT, the authentication parameter of the ONT after completing ranging of the terminal with the temporary terminal ID.

With reference to the first aspect or the first possible implementation manner of the first aspect, in a third possible implementation manner, the recording, by the OLT, a terminal serial number obtained from the authorized terminal, and recording a terminal ID allocated for the authorized terminal includes recording, by the OLT, a serial number of the authorized terminal received by the OLT, and allocating, by the OLT, a formal terminal ID for the authorized terminal, and recording the formal terminal ID of the authorized terminal

According to a second aspect, an embodiment of the present disclosure further provides an OLT, which includes: a first storage module configured to store an authentication parameter of an ONT, where the authentication parameter is used to identify the ONT of a same type; a receiving module configured to receive a registration request that carries the authentication parameter and is sent by the ONT, where the authentication parameter is used to identify the ONT of a same type; a processing module configured to determine that the authentication parameter sent by the ONT matches an authentication parameter preconfigured on the OLT, and if the authentication parameter matches, authorizing that the ONT of the same type is an authorized ONT.

In a first possible implementation manner of the second aspect, the receiving module is further configured to receive a terminal serial number.

In a second possible implementation manner of the second aspect, the OLT further includes a distribution module configured to allocate a terminal ID for the ONT, and a second storage module configured to, after authorizing that the ONT of the same type is an authorized ONT, store the serial number of the ONT received by the receiving module and the terminal ID output by the distribution module.

In a third possible implementation manner of the second aspect, the distribution module includes a determining submodule configured to determine whether the serial number of the ONT received by the receiving module is recorded in the serial number of the ONT stored in the second storage module; a distribution submodule configured according to a determination result of the determining submodule, if yes, allocate a formal terminal ID for the ONT; and if no, allocate a temporary terminal ID for the terminal; and trigger ranging processing of the OLT.

In a fourth possible implementation manner of the second aspect, the receiving module includes: a first request submodule configured to request a terminal serial number of the ONT; a second request submodule configured to, after the OLT on which the second request submodule is located completes ranging, request the authentication parameter of the ONT; and a receiving submodule configured to receive the authentication parameter and serial number of the ONT.

According to a third aspect, an embodiment of the present disclosure further provides an optical network system. The optical network system includes an OLT and at least one ONT, where the OLT is connected to the at least one ONT using an optical distribution network, and the OLT is the OLT described in the second aspect or any one of the first to the fourth possible implementation manners of the second aspect; and the ONT configured to, according to a received request of the OLT, send an authentication parameter to the OLT.

In a first possible implementation manner of the third aspect, the ONT is further configured to, according to a request of the OLT, send a terminal serial number to the OLT.

It can be learned from the description of the foregoing technical solution that, in an implementation manner of the present disclosure, a consistent and corresponding authentication parameter is separately preconfigured on an OLT side and on a terminal side, so that an OLT may authenticate an authorized terminal of a same type, and an OLT automatically saves a serial number sent by the terminal locally, thereby configuring a service for the OLT, without needing to manually input authentication information, that is, plug and play, which improves automation and flexibility of authentication and enhances user experience.

### BRIEF DESCRIPTION OF DRAWINGS

To describe the technical solutions in the embodiments of the present disclosure or in the prior art more clearly, the following briefly introduces the accompanying drawings required for describing the background and the embodiments. The accompanying drawings in the following description show merely some embodiments of the present disclosure, and a person of ordinary skill in the art may still derive other drawings or embodiments according to these accompanying drawings or the description without creative efforts, and the present disclosure aims to cover all these derived drawings or embodiments.

FIG. 1 is a schematic diagram of an architecture of a passive optical network according to the present disclosure;

FIG. 2 is a schematic flowchart of a terminal authentication method in a passive optical network according to an embodiment of the present disclosure; and

FIG. 3 is a schematic diagram of a module of an OLT according to an embodiment of the present disclosure.

### DETAILED DESCRIPTION OF EMBODIMENTS

To make the objectives, technical solutions, and advantages of the present disclosure clearer and more comprehensible, the following further describes the present disclosure in detail with reference to the accompanying drawings and embodiments. It should be understood that the specific embodiments described herein are merely used to explain the present disclosure but are not intended to limit the present disclosure. The described embodiments are merely a part rather than all of the embodiments of the present disclosure. All other embodiments obtained by a person of ordinary skill in the art based on the embodiments of the present disclosure without creative efforts shall fall within the protection scope of the present disclosure.

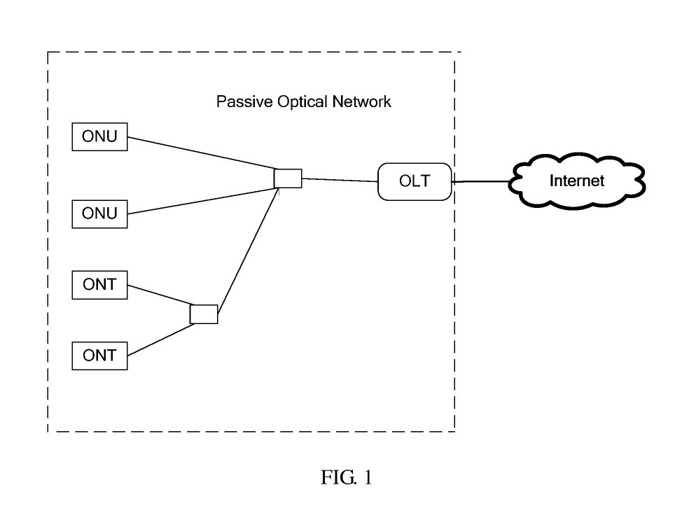

FIG. 1 is a schematic diagram of an architecture of an optical network on which the embodiments of the present disclosure are based. As shown in FIG. 1, in a passive optical network system, a plurality of ONTs or ONUs is connected to an OLT using an ODN (not shown in FIG. 1). The OLT provides a network side interface for the PON system for connecting one or more ODNs. The ODN is a passive optical splitting device and splits OLT downlink data and transmits to each ONU, meanwhile, combines uplink data of a plurality of ONUs/ONTs and transmits to the OLT. The ONU provides a user side interface for the PON system. In the uplink, the ONU is connected to the ODN. If the ONU directly provides a user port function, for example, an Ethernet user port for a personal computer (PC) to access the Internet, the ONU is referred to as an ONT. The ONU mentioned in the following uniformly refers to an ONU and ONT.

In the embodiments of the present disclosure, an authentication parameter is preconfigured on an OLT to implement automatic authentication of an ONT of a same type. For the convenience of description, in the present disclosure, the optical line terminal is referred to as OLT for short, and the optical network unit is referred to as ONU for short. The following describes an ONU detection and authentication method in a PON network in detail according to an implementation manner of the present disclosure.

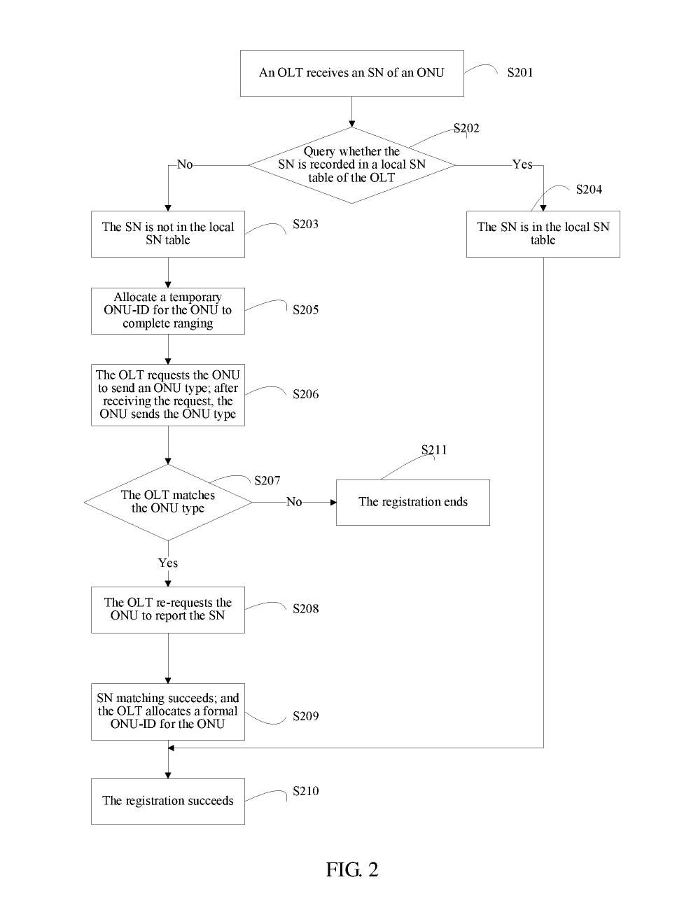

The following describes a terminal authentication method according to the implementation manner of the present disclosure with reference to an accompanying drawing, as shown in FIG. 2.

S201: An OLT receives an SN of an ONU.

In this step, before the ONU sends a registration request message that carries the SN to the OLT, the OLT first sends an initial state message and ready state message to the ONU, and then requests the ONU/ONT to send a SN request to the OLT. Both the initial state message and ready state message are the prior art, and details are not described herein again.

S202: Query whether the SN is recorded in a local SN table of the OLT.

In this step, the OLT locally stores in a SN table, as shown in Table 1 (content in the table is exemplary description):

TABLE 1
Serial number (SN) table

| No. | SN |
|---|---|
| 1 | 123456 |
| 2 | 568923 |
| 3 | . . . |

S203: If the SN is not recorded in the local SN table, save the SN, and then go to step S205.

S204: If the SN is already recorded in the local SN table, go to step S210.

If the SN is already recorded in the local SN table, authentication succeeds, and service information is directly delivered to the ONU.

S205: The OLT allocates a temporary ONU-ID (terminal ID) for the ONU and completes ranging.

That the OLT allocates a temporary terminal ID for the ONU may meet an implementation requirement of the ONU in a registration process. For example, when the ONU transmits the SN to the OLT using an uplink message, a temporary terminal ID may be first allocated for the ONU to complete a subsequent ranging procedure.

S206: The OLT requests the ONU to send an authentication parameter, such as an ONU type. After receiving the request, the ONU sends an authentication parameter.

The OLT transmits the authentication parameter using the OMCI protocol. After receiving the request, the ONU may also report authentication parameter information using an OMCI message.

A specific structure of the foregoing OMCI message may be shown in Table 2.

TABLE 2
Packet format of an OMCI message
Message for requesting an authentication parameter

| Byte | Content | Description |
|---|---|---|
| 1~2 | Transaction Correlation Identifier | Identifier priority |
| 3 | Message Type | Message type |
| 4 | Device identifier | OXOA |
| 5~8 | Message Identifier | Target entity and entity |
| | | status |
| 9~41 | Message Contents | Message content |
| 42~50 | OMCI Trailer | OMCI trailer field |

In Table 2, the most significant bit in bytes 1 to 2 Transaction Correlation Identifier indicates a high or low priority of the message: 1 indicates a high priority, and 0 indicates a low priority.

Message type is used to identify a type of the message, that is, which request is completed by the message.

Device Identifier, according to the definition in G984.4, is OXOA, which indicates OMCI.

The first two bits of Message Identifier indicate a target entity, and the latter two bits indicate an entity status.

Message Contents carries the ONU authentication parameter information.

OMCI Trailer is a trailer field of OMCI.

The foregoing Table 2 is merely a specific example of a message for requesting an authentication parameter. In the implementation manner of the present disclosure, a message for transmitting an authentication parameter is not limited to the foregoing specific example, for example, a physical layer operations, administrations and maintenance (PLOAM) message may be used to carry the authentication parameter.

S207: The OLT matches the received authentication parameter. If matching fails, go to S211.

In this step, the authentication parameter is preconfigured on the OLT, and herein the preconfiguring may be establishing an authentication parameter table in a host database of the OLT. The authentication parameter table is used to store parameter information of all ONUs connected to the OLT, as shown in Table 3. The preconfiguring may also be using an external input manner by the OLT, for example, using a host command line and a network management system.

TABLE 3
Authentication parameter table

| No. | Authentication parameter |
|---|---|
| 1 | SmartAX MA5694 |
| 2 | SmartAX MA5600 |

Further, an authentication parameter is preconfigured on the ONU, herein the preconfiguring may be writing the authentication parameter into a memory of the ONU or using an external input manner by inputting an authentication parameter in the network management or command line of the ONU. Certainly, authentication parameters preconfigured on the OLT and ONU should be the same and correspond in a one-to-one manner.

Herein the authentication parameter is, in the GPON and EPON, used to identify an ONU of a same type. The authentication parameter may be one of or any combination of an ONU device name, software version information, ONU hardware version information, and a specific model of the ONU. For example, the ONU device name applied to the GPON is Smart AX MA5694, where the device name identifies an ONU of this type.

Further, after receiving the authentication parameter reported by the ONU, the OLT queries the authentication parameter table, as shown in Table 3. If data consistent with the reported authentication parameter exists in the table, it indicates that the authentication succeeds. If data consistent with the reported authentication parameter does not exist in the table, it indicates that the authentication fails, the authentication ends, and the ONT is kicked offline.

S208: If the matching succeeds, the OLT re-requests the ONU to report the SN.

If the matching of the authentication parameter succeeds, the OLT resends a message to the ONU to request an SN. After receiving the request, the ONU reports its own SN.

S209: SN matching succeeds. The OLT allocates a formal ONU-ID for the ONU.

In S203, the SN of the ONU has been saved already. Therefore, the SN matching succeeds, and the OLT allocates a formal ONU-ID for the ONU to complete a subsequent ranging operation.

S210: The ranging is complete, and the registration succeeds.

After the ONU registration succeeds, the OLT delivers service information to the ONU.

S211: The registration fails and ends.

The ONU registration fails, and the OLT kicks the ONU offline. The authentication ends.

Using the foregoing technical solutions, the OLT may be, during ONU registration and authentication, plug-and-play, without needing to input authentication information in the OLT and ONU, which improves automation and flexibility of authentication.

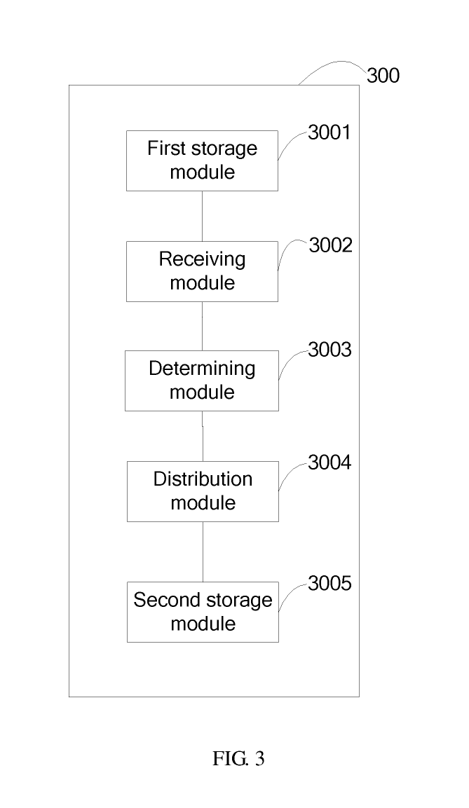

An embodiment of the present disclosure further provides a PON OLT 300, as shown in FIG. 3, including a first storage module 3001, a receiving module 3002, a determining module 3003, a distribution module 3004, and a second storage module 3005.

The first storage module 3001 is configured to store an authentication parameter of an ONT. The authentication parameter stored in the first storage module 3001 may be configured using an operation management system of the OLT, or configured in an external input manner, for example, a command line and a Web page.

The receiving module 3002 is configured to receive a SN, an authentication parameter, or a Password sent by the terminal ONU/ONT. The receiving module 3002 includes two subunits: a sending unit and a receiving unit. The sending unit is configured to send a message to the ONU/ONT to request an SN, an authentication parameter, and a password. The receiving unit is configured to receive a message of the SN, authentication parameter, and password reported by the ONU/ONT according to a request sent by the sending unit.

The determining module 3003 is configured to determine whether the authentication parameter received by the receiving module 3002 matches the authentication parameter stored in the first storage submodule 3001, so as to determine whether the terminal is an authorized terminal. The determining module 3003 outputs determination result information. For example, the determining module 3003 outputs matching information or mismatching information.

The distribution module 3004 is configured to allocate a terminal ID for a terminal and output the terminal ID. The distribution module 3004 may allocate a terminal ID for a terminal before the determining module 3003 performs determining, or allocate a terminal ID for a terminal after the determining module 3003 performs determining.

The second storage module 3005 is configured to, after the determining module 3003 outputs the matching determination result information, store the authentication parameter received by the receiving module 3002 and the terminal ID output by the distribution module 3004. The authentication parameter and terminal ID stored in the second storage module 3005 are a terminal serial number and terminal ID of an authorized terminal that is automatically detected.

Further, the distribution module 3004 includes a determining submodule and a distribution submodule, and the receiving module 3002 includes a first request submodule, a second request submodule, and a receiving submodule.

The first request submodule sends to all ONUs/ONTs a request message for requesting an ONU/ONT to report an SN. The receiving submodule receives the SN reported by an ONU/ONT. The determining submodule, after the receiving submodule receives an SN reported by the ONU/ONT, determines whether the SN received by the receiving submodule is recorded by the second storage module 3005, that is, determining whether the received SN matches an SN stored in the second storage module 3005. If the determining submodule determines that the SN received by the receiving submodule is an SN recorded by the second storage module 3005, the determining submodule informs the distribution submodule of allocating a formal ONU-ID. If the determining submodule determines that the SN received by the receiving submodule is not an SN recorded by the second storage module 3005, the determining submodule informs the distribution submodule of allocating a temporary ONU-ID.

After receiving information of allocating a temporary ONU-ID from the determining submodule, the distribution submodule allocates a temporary ONU-ID for the terminal and triggers the OLT 300 to perform ranging for the terminal. The OLT 300 performs data interaction with the ONU/ONT allocated with a temporary ONU-ID and completes the ranging of the ONU/ONT allocated with a temporary ONU-ID.

The second request submodule, after the OLT 400 completes the ranging, sends an authentication parameter request message to the ONU/ONT, where the authentication parameter request message may be implemented using an OMCI request message or using a newly defined authentication parameter request message. The receiving submodule obtains the authentication parameter reported by the ONU/ONT from the received message.

The determining module 3003, after the receiving submodule receives the authentication parameter, performs verification on the authentication parameter received by the receiving submodule according to the authentication parameter stored in the first storage submodule 3001, that is, the determining module 3003 determines whether the authentication parameter received by the receiving submodule matches the authentication parameter stored in the first storage submodule 3001: if the authentication parameter received by the receiving submodule matches the authentication parameter stored in the first storage submodule 3001, if yes, authorizes that the ONU/ONT is an authorized terminal and informs the second storage module 3005 of recording the SN of the ONU/ONT; if the authentication parameter received by the receiving submodule does not match the authentication parameter stored in the first storage submodule 3001, confirms that the ONU/ONT is a non-authorized terminal, and directly terminates a registration procedure.

After the ONU/ONT is online again, a subsequent registration process is performed. The ONU/ONT reports its own SN to the OLT. After the receiving submodule receives the SN reported by the ONU/ONT, the determining submodule searches whether the SN is recorded in the second storage module 3005. If the determining submodule determines that the SN received by the receiving submodule is an SN recorded in the second storage module 3005, informs the distribution submodule of allocating a formal ONU-ID for the terminal If the determining submodule determines that the SN received by the receiving submodule is an SN that is not recorded in the second storage module, informs the distribution submodule of allocating a temporary ONU-ID for the terminal

In a process of the terminal going online again, the second storage module 3005 records the SN of the ONU/ONT. Therefore, the distribution submodule, after the receiving submodule receives the SN, searches the ONU-ID, allocates the searched ONU-ID as a formal ONU-ID to the terminal, and triggers the OLT 300 to perform ranging for the ONT. The OLT 300 performs data interaction with the ONU/ONT allocated with a formal ONU-ID and completes the ranging of the ONU/ONT allocated with a formal ONU-ID. The OLT 300 performs data interaction with the ONU/ONT allocated with a formal ONU-ID to carry out registration of the ONU/ONT. After the registration succeeds, the OLT performs data interaction with the ONU/ONT that is registered successfully, so as to configure a service parameter for the ONU/ONT that is registered successfully.

Using the foregoing technical solutions, the OLT 300 may be, during ONU registration and authentication, plug-and-play, without needing to input authentication information in the OLT, which improves automation and flexibility of authentication.

An embodiment of the present disclosure further provides an optical network system, and a specific networking structure as shown in FIG. 1. The optical network system includes the OLT 300 provided by the embodiments of the present disclosure and at least one ONT. The OLT 300 is connected to the at least one ONT using an optical distribution network. The OLT 300 includes a first storage module 3001, a receiving module 3002, a determining module 3003, a distribution module 3004, and a second storage module 3005.

The first storage module 3001 is configured to store an authentication parameter of an ONT. The authentication parameter stored in the first storage module 3001 may be configured using an operation management system of the OLT, or configured in an external input manner, for example, a command line and a Web page.

The receiving module 3002 is configured to receive a SN, an authentication parameter, or a password sent by the terminal ONU/ONT. The receiving module 3002 includes two subunits: a sending unit and a receiving unit. The sending unit is configured to send a message to the ONU/ONT to request an SN, an authentication parameter, and a password. The receiving unit is configured to receive the message of the SN, authentication parameter, and password reported by the ONU/ONT according to a request sent by the sending unit.

The determining module 3003 is configured to determine whether the authentication parameter received by the receiving module 3002 matches the authentication parameter stored in the first storage module 3001, so as to determine whether the terminal is an authorized terminal. The determining module 3003 outputs determination result information. For example, the determining module 3003 outputs matching information or mismatching information.

The distribution module 3004 is configured to allocate a terminal ID for a terminal and output the terminal ID. The distribution module 3004 may allocate a terminal ID for a terminal before the determining module 3003 performs determining, or allocate a terminal ID for a terminal after the determining module 3003 performs determining.

The second storage module 3005 is configured to, after the determining module 3003 outputs the matching determination result information, store the authentication parameter received by the receiving module 3002 and the terminal ID output by the distribution module 3004. The authentication parameter and terminal ID stored in the second storage module 3005 are a terminal serial number and terminal ID of an authorized terminal that is automatically detected.

For content of message interaction between the OLT 300 and ONT, reference may be made to FIG. 2 and the description of the embodiment corresponding to FIG. 2, and details are not described herein again.

Using the foregoing technical solutions, the OLT 300 may be, during ONU registration and authentication, plug-and-play, without needing to input authentication information in the OLT, which improves automation and flexibility of authentication.

The foregoing descriptions are merely several embodiments of the present disclosure, a person skilled in the art may make various modifications or variants according to disclosures of the application file, without departing from the spirit and scope of the present disclosure.

What is claimed is:

1. A terminal authentication method in a passive optical network (PON), wherein the PON comprises an optical line terminal (OLT) and at least one optical network terminal (ONT), wherein the OLT is connected to at least one ONT using an optical distribution network (ODN), and an authentication parameter is preconfigured on the OLT, and wherein the method comprises:
receiving, by the OLT, a registration request that carries an authentication parameter which is sent by the ONT, wherein the authentication parameter is used to identify the ONT of a same type;
determining, by the OLT, that the authentication parameter sent by the ONT matches the authentication parameter preconfigured on the OLT; and
confirming that the ONT of the same type is an authorized ONT.

2. The method according to claim 1, further comprising:
recording, by the optical line terminal, a terminal serial number obtained from the authorized terminal; and
recording a terminal identifier (ID) allocated for the authorized ONT.

3. The method according to claim 1, wherein the authentication parameter is transmitted using an ONT management and control interface message.

4. The method according to claim 1, wherein before receiving, by the optical line terminal, the registration request that carries the authentication parameter and that is sent by the optical network terminal, the method further comprises:
receiving, by the OLT, a terminal serial number sent by the ONT;
allocating a temporary terminal ID for the ONT; and
requesting, by the OLT, the authentication parameter of the ONT after completing ranging of the terminal with the temporary terminal ID.

5. The method according to claim 2, wherein recording, by the OLT, a terminal serial number obtained from the authorized terminal, and recording a terminal ID allocated for the authorized terminal, comprises:
recording, by the OLT, a serial number of the authorized terminal received by the OLT;
allocating, by the OLT, a formal terminal ID for the authorized terminal; and
recording the formal terminal ID of the authorized terminal.

6. An optical line terminal (OLT), comprising:
a first memory configured to store an authentication parameter of an optical network terminal (ONT), wherein the authentication parameter is used to identify the ONT of a same type;
a receiver configured to receive a registration request that carries the authentication parameter and is sent by the ONT, wherein the authentication parameter is used to identify the ONT of a same type; and
a processor coupled to the memory and the receiver and configured to:
determine whether the authentication parameter sent by the ONT matches an authentication parameter preconfigured on the OLT; and
authorize that the optical network terminal of the same type is an authorized optical network terminal when the authentication parameter sent by the ONT matches an authentication parameter preconfigured on the OLT.

7. The OLT according to claim 6, wherein the receiver is further configured to receive a terminal serial number.

8. The OLT according to claim 6, further comprising:
a distributer configured to allocate a terminal ID for the ONT; and
a second memory configured to store the serial number of the ONT received by the receiver and the terminal ID output by the distributer after authorizing that the ONT of the same type is an authorized ONT.

9. The OLT according to claim 6, wherein the distributer is further configured to:
determine whether the serial number of the ONT received by the receiver is recorded in the serial number of the ONT stored in the second memory;
allocate a formal terminal ID for the ONT when the serial number of the ONT received by the receiver is recorded in the serial number of the ONT stored in the second memory;
allocate a temporary terminal ID for the terminal when the serial number of the ONT received by the receiver is not recorded in the serial number of the ONT stored in the second memory; and
trigger ranging processing of the OLT.

10. The OLT according to claim 6, wherein the processor is further configured to:
request a terminal serial number of the ONT;
request the authentication parameter of the ONT after the OLT completes ranging; and
receive the authentication parameter and serial number of the ONT.

11. A passive optical network (PON) system, comprising:
an optical line terminal (OLT);
an optical network terminal (ONT),
wherein the OLT is connected to the ONT using an optical distribution network (ODN),
wherein the ONT is configured to send a registration request which carries an authentication parameter to the OLT, wherein the OLT is configured to:
receive the registration request that carries the authentication parameter sent by the ONT, wherein the authentication parameter is used to identify the ONT of a same type;
determine whether the authentication parameter sent by the ONT matches an authentication parameter preconfigured on the OLT; and
confirm the ONT of the same type is an authorized ONT.

12. The optical network system according to claim 11, wherein the ONT is further configured to send a terminal serial number to the OLT according to a request of the OLT.
